(19) United States
(12) Patent Application Publication
(10) Pub. No.: US 2025/0138975 A1
(43) Pub. Date: May 1, 2025

(54) RESOURCE PROCESSING METHOD AND STORAGE MEDIUM

(71) Applicant: Hangzhou AliCloud Feitian Information Technology Co., Ltd., Hangzhou City (CN)

(72) Inventors: Huangshi TIAN, Hangzhou (CN); Tianlong WU, Hangzhou (CN)

(21) Appl. No.: 18/685,202

(22) PCT Filed: Jan. 13, 2023
(86) PCT No.: PCT/CN2023/072183

§ 371 Date: Feb. 20, 2024

(30) Foreign Application Priority Data
Jan. 18, 2022 (CN) 202210056129.9
Jan. 21, 2022 (CN) 202210072247.9

(51) Int. Cl. G06F 11/34; G06F 9/50

(52) U.S. Cl. CPC G06F 11/3433; G06F 9/5077; G06F 11/3419

(57) ABSTRACT

The present disclosure discloses a resource processing method and a storage medium. The method includes: acquiring a target container of a target function, where the target container is configured to run the target function; acquiring a current resource that is already allocated to the target container; regulating the current resource to a target resource of the target container, where the target resource is determined based on the target function; and running, based on the target resource, the target function in the target container. According to the present disclosure, the technical problem of low resource utilization can be solved.

### CROSS-REFERENCE TO RELATED APPLICATIONS

The present application is a National Stage of International Application No. PCT/CN2023/072183, filed on Jan. 13, 2023, which claims priority to: Chinese Patent Application No. 202210056129.9, filed on Jan. 18, 2022 to the China National Intellectual Property Administration and entitled “RESOURCE PROCESSING METHOD AND STORAGE MEDIUM”; and Chinese Patent Application No. 202210072247.9, filed on Jan. 21, 2022 to the China National Intellectual Property Administration and entitled “RESOURCE PROCESSING METHOD AND STORAGE MEDIUM”. All of the above applications are incorporated into the present disclosure by reference in their entireties.

### TECHNICAL FIELD

The present disclosure relates to the fields of cloud computing and resource processing, specifically to a resource processing method and a storage medium.

### BACKGROUND

At present, when a function as service (abbreviated as FaaS) platform provides a computing service of function granularity to a user, a placement decision at the time of creation of a container in the life cycle thereof only takes into account of a requirement of fixed sized resources but does not take into account of the actual memory usage. For example, the container only uses 20% to 60% of its allocated memory, there is a technical problem of low resource utilization.

For the problem mentioned above, no effective solution has been proposed currently.

### SUMMARY

Embodiments of the present disclosure provides a resource processing method and a storage medium, to at least solve the technical problem of low resource utilization.

According to an aspect of the embodiments of the present disclosure, a resource processing method is provided. The method includes: acquiring a target container of a target function, where the target container is configured to run the target function; acquiring a current resource already allocated to the target container; regulating the current resource to a target resource of the target container, where the target resource is determined based on the target function; and running, based on the target resource, the target function in the target container.

In an implementation, for regulating the current resource to the target resource of the target container, the method includes: reducing the current resource to the target resource, in response to the current resource not being fully utilized for the target container.

In an implementation, for regulating the current resource to the target resource of the target container, the method further includes: acquiring an average historical resource used by the target function during a historical period, where historical resources include the average historical resource; and determining the target resource based on the historical period and the average historical resource.

In an implementation, the method further includes: acquiring profile data of the target function, where the profile data includes a maximum number of target containers allowed to be allocated to a virtual machine when the target container of the target function is co-located with a container of another function on the virtual machine; and determining, based on the profile data, a number of target containers allocated to the virtual machine.

In an implementation, the method further includes: monitoring the target container to obtain a first monitoring result; and performing migration processing or isolation processing on the target container, in response to the first monitoring result being used to indicate a performance degradation of the target function.

According to another aspect of the embodiments of the present disclosure, a resource processing apparatus is provided. The apparatus includes: a first acquiring unit, configured to acquire a target container of a target function, where the target container is configured to run the target function; a second acquiring unit, configured to acquire a current resource already allocated to the target container; a first regulating unit, configured to regulate the current resource to a target resource of the target container, where the target resource is determined based on the target function; and a first running unit, configured to run, based on the target resource, the target function in the target container.

According to another aspect of the embodiments of the present disclosure, a resource processing apparatus is provided from a virtual machine cluster side. The apparatus includes: a first determination unit, configured to determine a target area where a virtual machine is located in a virtual machine cluster; a second determination unit, configured to determine a target container of a target function based on the target area, where the target container of the target function is allowed to be allocated to the virtual machine, and the target container is configured to run the target function; a second regulating unit, configured to regulate a current resource already allocated to the target container to a target resource of the target container, where the target resource is determined based on the target function; a second running unit, configured to run, based on the target resource, the target function in the target container.

An embodiment of the present disclosure further provides a computer-readable storage medium. The computer-readable storage medium includes a program stored therein, where when the program is run by a processor, a device where the computer-readable storage medium is located is controlled to execute the resource processing method of the embodiments of the present disclosure.

An embodiment of the present disclosure further provides a processor. The processor is configured to run a program, where when the program is run, the resource processing method of the embodiments of the present disclosure is executed.

An embodiment of the present disclosure further provides a resource processing system. The system may include: a processor; and a memory, connected with the processor and configured to provide, to the processor, instructions for processing the following processing steps: acquiring a target container of a target function, where the target container is configured to run the target function; acquiring a current resource already allocated to the target container; regulating the current resource to a target resource of the target container, where the target resource is obtained based on a historical resource that is used by the target function during a historical period; and running, based on the target resource, the target function in the target container.

In the embodiments of the present disclosure, the way of regulating a container placement and requesting a route is adopted. By means of: acquiring a target container of a target function, where the target container is configured to run the target function; acquiring a current resource already allocated to the target container; regulating the current resource to a target resource of the target container, where the target resource is determined based on the target function; and running, based on the target resource, the target function in the target container. That is to say, in the present disclosure, by reducing the allocated memory to an actual used part of each container of the function, the resource usage amount is reduced while ensuring that the performance of the function remains unchanged, the technical problem of low resource utilization is solved and the technical effect of improving resource utilization is achieved.

### BRIEF DESCRIPTION OF DRAWINGS

The drawings described here are intended to provide a further understanding of the present disclosure and form a part of the present disclosure. The illustrative embodiments of the present disclosure and their explanations are used to explain the present disclosure and do not constitute an improper limitation of the present disclosure.

FIG. 1 is a block diagram of a hardware structure of a computer terminal (or a mobile device) for implementing a resource processing method according to an embodiment of the present disclosure.

FIG. 2 is a flowchart of a resource processing method according to an embodiment of the present disclosure.

FIG. 3 is a flowchart of a resource processing method provided from a virtual machine cluster side according to an embodiment of the present disclosure.

FIG. 4 is a schematic diagram of a system service process according to an embodiment of the present disclosure.

FIG. 5 is an overall architecture diagram of a new FaaS platform scheduling system according to an embodiment of the present disclosure.

FIG. 6 is a schematic diagram of a resource processing apparatus according to an embodiment of the present disclosure.

FIG. 7 is a schematic diagram of a resource processing apparatus provided from a virtual machine cluster side according to an embodiment of the present disclosure.

FIG. 8 is a block diagram of a structure of a computer terminal according to an embodiment of the present disclosure.

### DESCRIPTION OF EMBODIMENTS

In order to enable those skilled in the art to better understand the solutions of the present disclosure, the technical solutions in the embodiments of the present disclosure will be described hereunder clearly and comprehensively in combination with the drawings in the embodiments of the present disclosure. Obviously, the described embodiments are part of the embodiments of the present disclosure, rather than all of them. All other embodiments obtained by those of ordinary skill in the art without any creative effort based on the embodiments in the present disclosure should belong to the protection scope of the present disclosure.

It should be noted that, the terms “first”, “second”, etc. in the description, claims, and the above-mentioned drawings of the present disclosure are used to distinguish similar objects, but not necessarily to describe a specific order or sequence. It should be understood that, the data used in this way is interchangeable where appropriate, so that the embodiments of the present disclosure described herein can be implemented in an order other than what is shown in the figures or what is described herein. In addition, the terms “include” and “have” and any variations of them are intended to cover non-exclusive inclusion. For example, processes, methods, systems, products or devices containing a series of steps or units are not necessarily limited to those steps or units that are clearly listed, but can include other steps or units that are not clearly listed or are inherent to these processes, methods, products or devices.

Firstly, some of the terms or terminologies used in describing the embodiments of the present disclosure are applicable to the following interpretations.

Function as a service (FaaS) platform: it is in a form of cloud computing service where a user uploads function codes to the platform and triggers execution of a function by sending a request, and where a service provider needs to manage the codes uploaded by the user and create a virtual machine and allocate a container for the user's function upon reception of the request.

Container: it is a carrier for running the function codes and configured to provide isolative computing, network and storage resources, etc. The same functions share a batch of containers, while different functions are isolated through containers.

Virtual manufacturing (abbreviated as VM): it may refer to a virtual machine, which is a carrier of a function instance; according to resource specifications of containers, several containers can be created on each virtual machine; multiple containers on a virtual manufacturing share computing, network, and storage resources, etc., of the virtual manufacturing.

Function profile: it is a multidimensional indicator, such as a central processing unit (abbreviated as CPU), a memory, a network, a delay, etc., extracted according to running characteristics of a function; it can be used to depict resource demand and delay sensitivity of the function as inputs for a scheduling decision.

Resource utilization: it is a proportion of time spent for executing a function to total time spent on resources of a virtual manufacturing; the higher the proportion, the higher the resource utilization.

### Embodiment 1

According to the embodiments of the present disclosure, an embodiment of a resource processing method is further provided. It should be noted that, steps shown in the flowchart of the drawings can be executed in a computer system, such as a set of computer executable instructions. Moreover, although a logical order is shown in the flowchart, the steps shown or described may be executed in an order different from that herein in some cases.

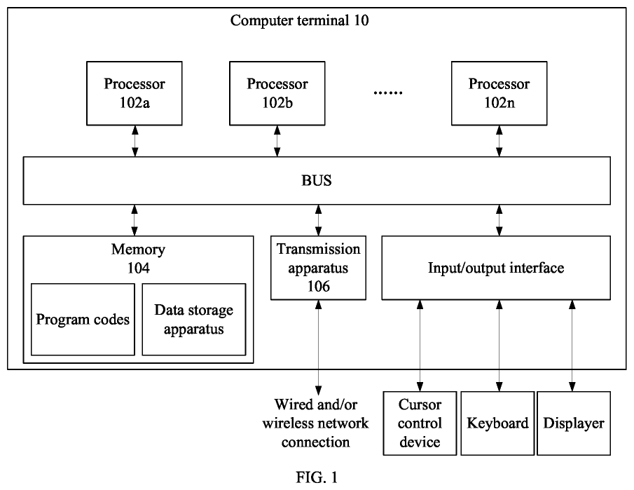

The method embodiment provided by Embodiment 1 of the present disclosure can be executed in a mobile terminal, a computer terminal, or a similar computing apparatus. FIG. 1 shows a block diagram of a hardware structure of a computer terminal (or a mobile device) for implementing a resource processing method. As shown in FIG. 1, a computer terminal 10 (or mobile device 10) may include: one or more (as shown in the figure using 102a, 102b, . . . , 102n) processors 102 (the processor 102 may include but not limited to a processing apparatus, such as a microprocessor MCU or a programmable logic device FPGA, etc.); a memory 104 configured to store data; and a transmission apparatus 106 for communication functions. In addition, it can also include: a displayer, an input/output interface (I/O interface), a universal serial bus (USB) port (which can be included as one of the ports of I/O interface), a network interface, a power supply, and/or a camera. Those of ordinary skill in the art can understand that, the structure shown in FIG. 1 is only for illustration and does not limit the structure of the electronic apparatus mentioned above. For example, the computer terminal 10 may also include more or fewer components than those shown in FIG. 1, or have a different configuration from that shown in FIG. 1.

It should be noted that the above-mentioned one or more processors 102 and/or other data processing circuits can commonly be referred to as a “data processing circuit” herein. The data processing circuit can be fully or partially presented as software, hardware, firmware, or any other combination. In addition, the data processing circuit can be a single independent processing module, or fully or partially integrated into any of other components in the computer terminal 10 (or mobile device). As involved in the embodiments of the present disclosure, the data processing circuit serves as a processor control (e.g. a selection of a terminal path for a variable resistor connected with an interface).

The memory 104 can be configured to store software programs and modules of application software, such as the program instructions/data storage apparatus corresponding to the resource processing method in the embodiments of the present disclosure. The processor 102 executes various functional applications and data processing by running the software programs and modules stored in the memory 104, thus the resource processing method mentioned above is implemented. The memory 104 may include a high-speed random access memory, and may also include a non-volatile memory, such as one or more magnetic storage apparatuses, flash memories, or other non-volatile solid-state memories. In some instances, the memory 104 may further include memories set remotely relative to the processor 102, these remote memories can be connected to the computer terminal 10 through a network. Instances of the network mentioned above include but are not limited to the internet, intranet, local area network, mobile communication network, and their combinations.

The transmission apparatus 106 is configured to receive or send data through a network. The specific instances of the network mentioned above may include wireless networks provided by communication providers of the computer terminal 10. In one instance, the transmission apparatus 106 includes a network adapter (Network Interface Controller, NIC) that can be connected with other network devices through a base station for communicating with the Internet. In one instance, the transmission apparatus 106 may be a radio frequency (RF) module used for communicating with the Internet in a wireless manner.

The displayer may be, for example, a touch screen type liquid crystal display (LCD), and the liquid crystal display enables users to interact with a user interface of the computer terminal 10 (or mobile device).

It should be noted here that, in some embodiments, the computer device (or mobile device) shown in FIG. 1 mentioned above may include hardware components (including circuits), software components (including computer codes stored on a computer readable medium), or a combination of hardware components and software components. It should be pointed out that, FIG. 1 is only one instance of specific concrete instances and is intended to illustrate the types of components that can exist in the computer device (or mobile device) mentioned above.

In the operating environment mentioned above, the embodiments of the present disclosure provide a resource processing method.

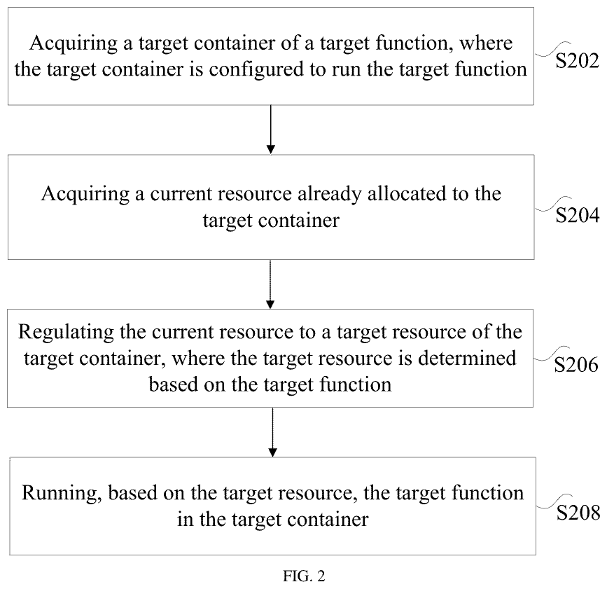

FIG. 2 is a flowchart of a resource processing method according to an embodiment of the present disclosure. As shown in FIG. 2, the resource processing method may include following steps.

Step S202, acquiring a target container of a target function, where the target container is configured to run the target function.

In the technical solution provided by step S202 mentioned above of the present disclosure, the target container of the target function can be acquired in the FaaS platform, where the FaaS platform can provide a computing service of function granularity to a user, the user uploads function codes to the platform, and when the user needs to perform a function, the platform creates a container in a cluster and execute the user's codes therein, in an implementation, the FaaS platform is a public cloud FaaS platform.

In this embodiment, the target container mentioned above can be a carrier for running function codes, which can provide isolative computing, network and storage resources, etc. The same functions share a batch of containers, while different functions are isolated through containers.

In this embodiment, the target function can be uploaded to the FaaS platform in the form of program codes, execution of the target function is implemented by sending a request, and a service provider creates a virtual machine and allocates a container for the target function upon reception of the request.

In an implementation of this embodiment, when acquiring the target container of the target function, it may be to acquire profile data of the target function, where the profile data includes a maximum number of target containers allowed to be allocated to a virtual machine when the target container of the target function is co-located with a container of another function on the virtual machine; and determine, based on the profile data, a number of target containers allocated to the virtual machine.

Step S204, acquiring a current resource already allocated to the target container.

In the technical solution provided by step S204 mentioned above of the present disclosure, after the user uploads the function codes to the platform, the user triggers execution of a function by sending a request, and a virtual machine is created and a container for the user's function is allocated upon reception of the request, thereby the current resource already allocated to the container is acquired.

In this embodiment, the current resource may be a resource provided to the user, such as a memory, a central processing unit, an input/output, etc., required for executing function codes, which will not be limited here.

Step S206, regulating the current resource to a target resource of the target container, where the target resource is determined based on the target function.

In the technical solution provided by step S206 mentioned above of the present disclosure, the current resource can be regulated to a target resource of the target container. For example, the target resource may be the actual used memory of each container; as the allocated resources are not fully utilized for most containers, an intuitive improvement is to reduce the allocated memory to the actual used memory of each container, which also constitutes the most basic idea of resource over-commitment.

Detailed elaboration is made by taking the memory as an example for the resource. For each function, its average historical used memory u is recorded, and assuming the length of its configured runtime is c, a scheduler, when creating a container, allocates memory [pu+(1−p)c] for it, where p is an adjustable percentage used for setting some buffer areas in the memory, operational personnel can adjust the resource over-commitment degree by adjusting the value p of each function.

In an implementation of this embodiment, in response to the current resource not being fully utilized for the target container, the current resource is reduced to the target resource.

In this embodiment, the target resource may be resources, such as an actual used memory a central processing unit and an input/output, etc. of each container, which will not be limited here.

In this embodiment, the target resource may be obtained based on a historical resource used by the target function during a historical period, or may be a value of the target function that has a certain mapping relationship with the target resource.

Step S208, running, based on the target resource, the target function in the target container.

In the technical solution provided by step S208 mentioned above of the present disclosure, the target function is run in the target container based on the target resource. For example, after the allocated memory is reduced to the actual used memory of each container, the function codes can be executed in the allocated container based on the actual used memory.

In an implementation of this embodiment, the target container is monitored to obtain a first monitoring result; and migration processing or isolation processing on the target container is performed, in response to the first monitoring result being used to indicate a performance degradation of the target function. For example, when the target function presents a performance degradation, a performance repair of the target function is mainly completed by the migration or the isolation on the container.

Throughout step 202 to step 208 mentioned above of the present disclosure, by means of: acquiring a target container of a target function, where the target container is configured to run the target function; acquiring a current resource already allocated to the target container; regulating the current resource to a target resource of the target container, where the target resource is obtained based on a historical resource that is used by the target function during a historical period; and running, based on the target resource, the target function in the target container; that is to say, in the present disclosure, by reducing the allocated memory to an actual used part of each container of the function, the resource usage amount is reduced while ensuring that the performance of the function remains unchanged, the technical problem of low resource utilization is solved and the technical effect of improving resource utilization is achieved.

The method mentioned above of this embodiment will be further introduced below.

As an implementation, step S206 includes: reducing the current resource to the target resource, in response to the current resource not being fully utilized for the target container.

In this embodiment, the target resource may be the actual used memory of each container; as the allocated resources are not fully utilized for most containers, the allocated memory can be reduced to the actual used memory of each container.

In this embodiment, in response to the current resource not being fully utilized for the target container, the current resource is reduced to the target resource. For example, when it is detected that the current resource is not fully utilized for the target container, a signal used for indicating this information is generated, and in response to this signal, the current resource is reduced to the actual used resource.

As an implementation, after reducing the current resource to the target resource, the method further includes: increasing the target container allocated to a virtual machine from an original number to a target number based on the target resource.

In this embodiment, the target container allocated to a virtual machine is increased from an original number to the target number based on the target resource. For example, resource enhancement is mainly achieved by resource over-commitment; when placing containers, the memory allocated to each container is reduced, the effect is a corresponding increase in the number of containers allocated to each virtual machine, and a decrease in the number of virtual machines required to serve the same number of containers, thereby saving the cost required for service operations.

As an implementation, step S206 further includes: acquiring an average historical resource used by the target function during a historical period, where historical resources include the average historical resource; and determining the target resource based on the historical period and the average historical resource.

Detailed elaboration is made by taking the memory as an example for the resource. For each function, its average historical used memory u is recorded, and assuming the length of its configured runtime is c, a scheduler, when creating a container, allocates memory [pu+(1−p)c] for it, where p is an adjustable percentage used for setting some buffer areas in the memory, operational personnel can adjust the degree of resource over-commitment by adjusting the value p of each function.

In this embodiment, the historical period may be a runtime configured for the function, the average historical resource may be the average historical used memory.

In this embodiment, the target resource is determined based on the historical period and the average historical resource. For example, when creating a container, the scheduler allocates memory [pu+(1−p) c] for the container.

As an implementation, the method further includes: acquiring a target parameter of the target function, where the target parameter is used to determine an over-commitment degree of the target resource; determining the target resource based on the historical period and the average historical resource includes: determining the target resource based on the historical period, the average historical resource, and the target parameter.

In this embodiment, the target parameter may be an adjustable percentage used for setting some buffer areas in the memory.

In this embodiment, determining the target resource based on the historical period and the average historical resource includes: determining the target resource based on the historical period, the average historical resource, and the target parameter. For example, when creating a container, the scheduler allocates memory [pu+(1−p)c] for it, where resource over-commitment can improve resource utilization.

As an implementation, step S201 includes: acquiring profile data of the target function, where the profile data includes a maximum number of target containers allowed to be allocated to a virtual machine when the target container of the target function is co-located with a container of another function on the virtual machine; and determining, based on the profile data, a number of target containers allocated to the virtual machine.

In this embodiment, the resource over-commitment can improve resource utilization, however the problem of performance degradation of the function may be caused at the same time. Therefore, we introduce a co-located profile for the function. When a placer follows the co-located profile to make a placement decision, the performance of the function can be ensured, where when some requests need creation of new containers, the placer can decide how to place them.

In this embodiment, the profile data of the target function may be data recording a maximum amount of the target containers that can be placed when the target function is co-located with another function on a virtual manufacturing.

In this embodiment, the profile data of the target function is acquired. For example, for obtaining the co-located profile, the scheduler will attempt to place containers of different functions on the same virtual manufacturing, and regulate the number of containers to observe whether the performance is affected; a maximum number observed will be recorded in the co-located profile.

In this embodiment, a number of target containers allocated to the virtual machine is determined based on the profile data. For example, containers will be placed onto a virtual machine in a cluster planned zone according to the co-located profile of functions, so the performance of containers in the planned zone is relatively stable.

As an implementation, acquiring the profile data of the target function includes: acquiring the profile data of the target function, in response to the virtual machine being located in a first target area.

In this embodiment, the first target area may be the cluster planned zone, and containers can be placed onto the virtual machine in the cluster planned zone according to the profile of the functions.

In this embodiment, in response to the virtual machine being located in a first target area, the profile data of the target function is acquired. For example, when it is detected that the virtual machine is located in the cluster planned zone, a signal for indicating this information is generated, and in response to this signal, the co-located profile of each function is acquired.

As an implementation, step S208 further includes: monitoring the target container to obtain a first monitoring result; and performing migration processing or isolation processing on the target container, in response to the first monitoring result being used to indicate a performance degradation of the target function.

In this embodiment, containers in a cluster mixed zone will not be placed according to the profile, so the performance of the containers needs to be protected by additional monitoring and repair mechanisms.

In this embodiment, the target container is monitored to obtain a first monitoring result. For example, the scheduler monitors the performance of the function mainly according to its established performance rule, the performance rule includes a standard for a delay of a function request to achieve within a period of time, for example, an average delay or a tail delay is below a specific value. The monitor will continuously read the delay of the function within a period of time in the past to determine whether the performance rule has been met correspondingly.

In this embodiment, the migration processing or the isolation processing on the target container is performed in response to the first monitoring result being used to indicate a performance degradation of the target function. For example, when it is detected that the target function presents a performance degradation, a signal used for indicating this information is generated, and in response to this signal, the migration processing or the isolation processing is performed on the target container.

As an implementation, the method further includes: monitoring the target container to obtain the first monitoring result, in response to a virtual machine to which the target container is allocated being located in a second target area.

In this embodiment, the second target area may be a cluster mixed zone, the cluster mixed zone allows for placement of containers of any functions together, and the objective of saving resources is achieved by resource over-commitment.

In this embodiment, the first monitoring result may be the performance of the target function.

In this embodiment, in response to a virtual machine to which the target container is allocated being located in a second target area, the target container is monitored to obtain the first monitoring result. For example, when it is detected that the container is located in the cluster mixed zone, a signal used for indicating this information is generated, and in response to this signal, the container located in the cluster mixed zone is monitored to obtain a performance result of the function.

As an implementation, monitoring the target container to obtain the first monitoring result, the method includes: acquiring a delay duration for the target function in responding to a target request in the target container; and determining that the first monitoring result is used to indicate the performance degradation of the target function, in response to the delay duration being greater than a target duration.

In this embodiment, the delay duration may follow a standard that an average delay or a tail delay of the function request is below a specific value within a period of time.

For example, for containers of the cluster mixed zone, the scheduler monitors the function performance mainly according to its established performance rule, the performance rule includes a standard for a delay of a function request to achieve within a period of time, for example, an average delay or a tail delay is below a specific value, the monitor will continuously read the delay of the function within a period of time in the past to determine whether the performance rule has been met correspondingly.

As an implementation, performing the migration processing on the target container, the method includes: migrating the target container from an original virtual machine to a target virtual machine, where the target virtual machine includes at least one of following: a virtual machine with a usage rate below a target threshold, a virtual machine already allocated with a same container as the target container, and a virtual machine located in a third target area without resource over-commitment.

In this embodiment, the third target area may be a cluster control zone. The cluster control zone is a non-over-commitment environment, which will be used as a benchmark for performance comparison and also as an ultimate way to improve performance.

For example, the container migration can follow different rules, for example, migrating the container to the virtual machine with the lowest usage rate or to the virtual machine with other identical containers, if the migration cannot effectively alleviate and fix the performance problem, the control zone in the cluster provides a series of virtual machines without resource over-commitment, a similar effect as isolation can be achieved after migrating the container.

As an implementation, after performing the migration processing or the isolation processing on the target container, the method further includes: monitoring the target container subjected to the migration processing or the isolation processing, to obtain a second monitoring result; and determining that the target function is in an abnormal state, in response to the second monitoring result being used to indicate the performance degradation of the target function.

In this embodiment, the target container subjected to the migration processing or the isolation processing is monitored to obtain a second monitoring result, for example, if the problem of performance degradation cannot be solved even after performing the migration processing or the isolation processing on the target container.

In this embodiment, it is determined that the target function is in an abnormal state, in response to the second monitoring result being used to indicate the performance degradation of the target function. For example, when it is detected that the problem of performance degradation cannot be solved even after performing the migration processing or the isolation processing on the target container, a signal used for indicating this information is generated, and in response to this signal, it indicates that the problem stems from the function itself, for example, there is a problem with a third-party dependency of the function.

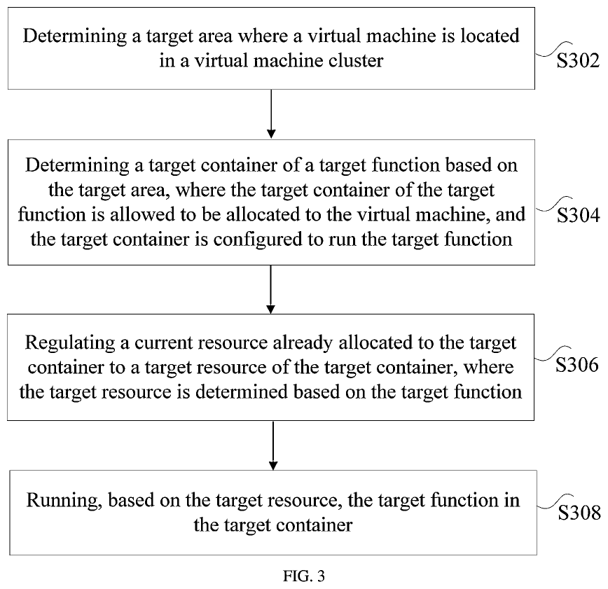

FIG. 3 is a flowchart of a resource processing method provided from a virtual machine cluster side according to an embodiment of the present disclosure. As shown in FIG. 3, the resource processing method may include following steps.

Step S302, determining a target area where a virtual machine is located in a virtual machine cluster. In the technical solution provided by step S302 mentioned above of the present disclosure, the target area may include: a planned zone, a mixed zone, and a control zone; containers can be placed on the virtual machine in the planned zone according to the profile of the function; containers of any functions can be placed together in the mixed zone, and the objective of saving resources is achieved by resource over-commitment; the control zone is a non-over-commitment environment, which will be used as a benchmark for performance comparison and also as an ultimate way to improve performance.

In this embodiment, the target area where the virtual machine is located in the virtual machine cluster can be determined, for example, the virtual machine is determined in one of the planned zone, the mixed zone, and the control zone.

Step S304, determining a target container of a target function based on the target area, where the target container of the target function is allowed to be allocated to the virtual machine, and the target container is configured to run the target function.

In the technical solution provided by step S304 mentioned above of the present disclosure, the target container of the target function can be determined based on the target area. For example, containers can be placed onto the virtual machine in the planned zone according to the co-located profile of the functions, when the function performance is decreased, if the migration cannot effectively alleviate and fix the performance problem, the control zone provides a series of virtual machines without resource over-commitment, a similar effect as isolation can be achieved after migrating the container.

In an implementation of this embodiment, the target container of the target function being allowed to be allocated to the virtual machine includes: acquiring profile data of the target function in response to the virtual machine being located in a first target area, where the profile data includes a maximum number of target containers allowed to be allocated to the virtual machine when the target container of the target function is co-located with a container of another function on the virtual machine.

For example, the first target area may be a cluster planned zone, the profile is recorded with a maximum amount of the target container that can be placed when the target function is co-located with another function on a virtual manufacturing. When a placer follows the co-located profile to make a placement decision, the performance of the functions can be ensured. For obtaining the co-located profile, the scheduler will attempt to place containers of different functions on the same virtual manufacturing, and regulate the number of containers to observe whether the performance is affected; a maximum number observed will be recorded in the co-located profile. Placement onto a virtual machine in a cluster planned zone is possible according to the co-located profile of the functions, so the performance of containers in the planned zone is relatively stable.

Step S306, regulating a current resource already allocated to the target container to a target resource of the target container, where the target resource is determined based on the target function.

In the technical solution provided by step S306 mentioned above of the present disclosure, the target resource is determined based on the target function. For example, the target resource may be obtained based on a historical resource that is used by the target function during a historical period, or may be a value of the target function that has a certain mapping relationship with the target resource.

In this embodiment, the current resource already allocated to the target container can be regulated to the target resource of the target container. For example, by using a resource over-commitment method, the current resource (such as the memory) already allocated to the target container is regulated to the target resource of the target container.

In an implementation of this embodiment, regulating the current resource already allocated to the target container to the target resource of the target container includes: monitoring the target container to obtain a first monitoring result, in response to a virtual machine to which the target container is allocated being located in a second target area; and performing migration processing or isolation processing on the target container, in response to the first monitoring result being used to indicate a performance degradation of the target function.

For example, the second target area may be a cluster mixed zone, containers in the cluster mixed zone may not be placed according to the profile, so the performance of the containers needs to be protected by additional monitoring and repair mechanisms; the scheduler monitors the performance of the function mainly according to its established performance rule, the performance rule includes a standard for a delay of a function request to achieve within a period of time, for example, an average delay or a tail delay is below a specific value; the monitor will continuously read the delay of the function within a period of time in the past to determine whether the performance rule has been met correspondingly; when the function presents a performance degradation, a performance repair is mainly completed by the migration or the isolation on the container.

In an implementation of this embodiment, regulating the current resource already allocated to the target container to the target resource of the target container further includes: migrating the target container from an original virtual machine to a target virtual machine, where the target virtual machine includes at least one of following: a virtual machine with a usage rate below a target threshold, a virtual machine already allocated with a same container as the target container, and a virtual machine located in a third target area without resource over-commitment.

For example, the third target area may be a cluster control zone, the container migration can follow different rules, for example, migrating the container to the virtual machine with the lowest usage rate or to the virtual machine with other identical containers, if the migration cannot effectively alleviate and fix the performance problem, the control zone in the cluster provides a series of virtual machines without resource over-commitment, a similar effect as isolation can be achieved after migrating the container.

Step S308, running, based on the target resource, the target function in the target container.

In the technical solution provided by step S308 mentioned above of the present disclosure, the target function can be run in the target container based on the target resource. For example, after the allocated memory is reduced to the actual used memory of each container, the function codes can be executed in the allocated container based on the actual used memory.

In the embodiments of the present disclosure, resource enhancement is mainly achieved by resource over-commitment; when placing containers, the memory allocated to each container is reduced, the effect is a corresponding increase in the number of containers allocated to each virtual machine, and a decrease in the number of virtual machines required to serve the same number of containers; at the same time, real-time monitoring on function performance is carried out, and alleviation or processing is promptly performed for a container that is problematic; therefore, the function performance will not be affected by resource over-commitment, the resource utilization of the cluster can be improved and the performance of containers is protected from being affected, the technical problem of low resource utilization is solved and the technical effect of improving resource utilization rate is achieved.

Other implementations of the method mentioned above of this embodiment will be further introduced below.

The FaaS platform provides a computing service of function granularity to a user, the user uploads function codes to the platform, and when the user needs to perform a function, the platform creates a container in a cluster and execute the user's codes therein. During the service process, the platform is confronted with two scheduling decisions:
1) when creating a container, the platform needs to select a suitable location from virtual manufacturings in the cluster. If the distribution of containers is too scattered, it will lead to a decreased utilization rate in the virtual manufacturings and increased operational costs of the platform; if the distribution is too concentrated, it will lead to mutual interference between containers, and the execution efficiency of the user function will be affected;
2) since for a single user function, multiple containers may be created on different virtual manufacturings, the platform needs to determine the location of the container for execution when executing the request.

FIG. 4 is a schematic diagram of a system service process according to an embodiment of the present disclosure; as shown in FIG. 4, the challenge of resource scheduling on the FaaS platform comes from the high heterogeneity of served customers, if there is only a single type of functions, both container placement and route requesting can be solved through simple algorithms.

Firstly, the FaaS platform has customers coming from different industries and companies, with a wide variety of functions, which leads to many problems faced by the scheduler. First of all, different functions have different resource demands; some functions persistently consume a large amount of CPU resources, some functions occupy a large amount of memory, and some functions use input/output (abbreviated as I/O) and other resources. How to combine different functions together and fully utilize all resources on each virtual manufacturing has become a challenge. Research has shown that algorithms for finding placement combinations have exponential complexity, given virtual manufacturings and tasks of a series of fixed resources. Therefore, the FaaS platform requires a fast and effective optimized algorithm.

Secondly, the number of functions served by the platform is huge. With the rapid development and iteration of cloud computing and FaaS products, the number of functions is also growing at an extremely fast pace, which puts higher requirements on the scalability of scheduling algorithms. When the number of functions is relatively small, the number of combinations between functions is also relatively small, and simple methods, such as traversal and enumeration, are still feasible. But as the number of functions increases, the scheduler cannot find a satisfied combination through simple searches. Therefore, this poses a challenge to the process optimization of the functions.

Finally, different functions have different requirements for performance. Some customer functions are on the critical path of their functionality, and a degradation in function performance can lead to a decrease in the overall quality of their functionality, therefore, this type of functions has extremely high requirements for performance. However, some customer functions belong to offline processing or asynchronous calling, and the function performance has no decisive impact on the customer functionality, so the requirements for the function performance are relatively low. However, for different functions, there is no performance differentiation in the current scheduling system, when the system has a problem, all functions may be affected, which will have a negative impact on performance sensitive users. In summary, the scheduler of the FaaS platform needs to achieve efficient resource utilization without affecting the function performance by regulating the container placement and requesting a route.

In the prior art, the scheduler of the FaaS platform is focused on simple linear searches. In the container placement problem, each virtual manufacturing has a different number of available resources, and a newly created container has a certain resource demand, therefore, the necessary condition for placement is that the available resources of the virtual manufacturing are greater than the demand of the container. The existing scheduler scans existing virtual manufacturings in a linear manner according to this requirement, and stops scanning when a virtual manufacturing meeting the condition is found, and creates a corresponding container on the virtual manufacturing. When no virtual manufacturing meets the requirement, the platform will create a new virtual manufacturing for cluster expansion.

When routing a request, the main strategy of the current scheduler is to route the request to the container that has recently executed the request. The purpose of this strategy is to keep as many containers as possible idle for as long as possible, so that they can be recycled as soon as possible, thereby improving the resource utilization. In the specific implementation, containers are sorted by when they are most recently called, the scheduler searches for an idle container in a linear scanning manner, and then sends the request to that container.

There are mainly two problems with the existing solution, one is the insufficient utilization of resources, and the other is the susceptibility of function performance to interference. A placement decision at the time of creation of a container in the life cycle thereof only takes into account of a requirement of fixed sized resources but does not take into account of the actual memory usage; the resident mechanism before release means that there is idleness in the CPU cycle. In most cases, the container only uses 20% to 60% of its allocated memory; in terms of the CPU, 40% of containers are idle for more than 10% of time, and 25% of sandboxes (as a type of container) are idle for more than 50% of time. When requesting a route, the existing solution only takes into account of the last use time of container, without taking into account of the last use time of other containers on the same virtual manufacturing, therefore, it is likely that too many containers on the same virtual manufacturing would be in an execution state, to form contention for resources, leading to a decrease in container performance.

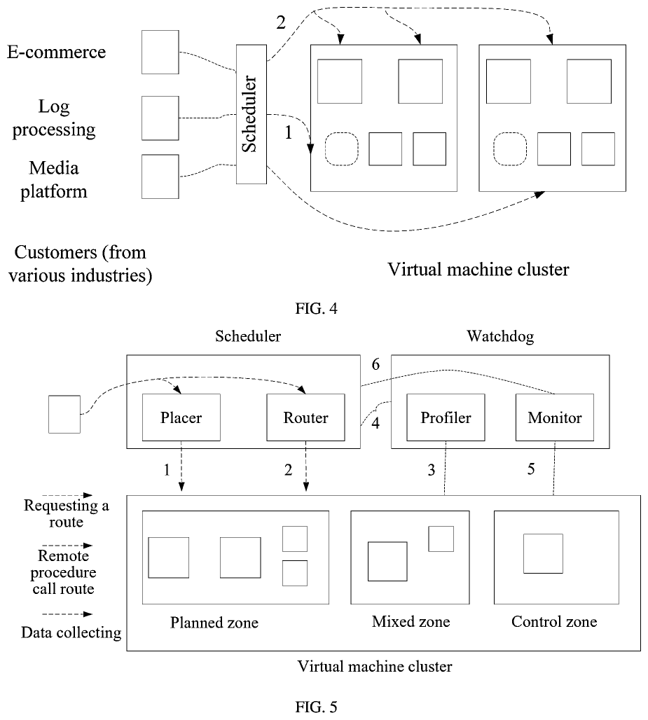

FIG. 5 is an overall architecture diagram of a new FaaS platform scheduling system according to an embodiment of the present disclosure; as shown in FIG. 5, the scheduler is located on the critical path of the service request, the watchdog runs at backend. The workflow of the FaaS platform scheduling system may be as follows:
1) when some requests require to create new containers, a placer decides how to place them;
2) most incoming requests are handled by the router that selects the containers for them, each function has its own router; the scheduler exposes a remote procedure call interface, allowing other components to update the status of routers and placers;
3) if the function has a sufficient number of requests, the profiler will profile the resource usage of the function and function co-location;
4) the profile information will be passed back to the scheduler to update the corresponding placement strategy;
5) when a function delay deviates from a normal value, the monitor will detect this decrease;
6) it will initiate an RPC call to the scheduler, to start performance diagnosis or performance repair.

A virtual machine cluster is logically divided into three zones. Containers will be placed onto the virtual machine in the planned zone according to the profile data of the function, the specific placement method will be explained in the following text. Containers of any functions will be placed together in the mixed zone, and the objective of saving resources is achieved by resource over-commitment. The monitor will persistently observe and fix the problem of performance degradation caused by the resource over-commitment. The control zone is a non-over-commitment environment, which will be used as a benchmark for performance comparison and also as an ultimate way to improve performance.

As the allocated resources are not fully utilized for most containers, an intuitive improvement is to reduce the allocated memory to the actual used part of each container, which also constitutes the most basic idea of resource over-commitment. Specifically, for each function, we record its average historical used memory u. And assuming the length of the configured runtime for the function is c, a scheduler, when creating a container, allocates memory [pu+(1−p)c] for it, where p is an adjustable percentage used for setting some buffer areas in the memory. Operational personnel can adjust the resource over-commitment degree by adjusting the value p of each function.

The resource over-commitment can improve resource utilization, however the problem of performance degradation of the function may be caused at the same time. Therefore, we introduce a co-located profile for the function. The profile is recorded with a maximum amount that can be placed when the function is co-located with another function on a virtual manufacturing. When a placer follows the co-located profile to make a placement decision, the performance of the function can be ensured. For obtaining the co-located profile, the scheduler will attempt to place containers of different functions on the same virtual manufacturing, and regulate the number of containers to observe whether the performance is affected; a maximum number observed will be recorded in the co-located profile. Containers will be placed onto a virtual machine in a cluster planned zone according to the co-located profile of the functions, so the performance of the containers in the planned zone is relatively stable.

Containers in the cluster mixed zone will not be placed according to the profile, so the performance of the containers need to be protected by additional monitoring and repair mechanisms. The scheduler monitors the performance of the function mainly according to its established performance rule. The performance rule includes a standard for a delay of a function request to achieve within a period of time, for example, an average delay or a tail delay is below a specific value. The monitor will continuously read the delay of the function within a period of time in the past to determine whether the performance rule has been met correspondingly.

When the function presents a performance degradation, a performance repair is mainly completed by the migration or the isolation on the container. The container migration can follow different rules, for example, migrating the container to the virtual machine with the lowest usage rate or to the virtual machine with other identical containers. If the migration cannot effectively alleviate and fix the performance problem, the control zone in the cluster provides a series of virtual machines without resource over-commitment, a similar effect as isolation can be achieved after migrating the container. If the isolation still cannot solve the problem of performance degradation, it indicates that the problem stems from the function itself, for example, there is a problem with a third-party dependency of the function. Therefore, this problem has exceeded the scope that service providers can solve.

According to the embodiments of the present disclosure, by designing a complete scheduling system for the public cloud FaaS platform, the technical effect of effectively improving resource utilization and reducing operational costs is achieved compared to existing systems; by designing a method of co-located profiling for different functions, the objective of depicting behaviors of different functions is accomplished, which can effectively demonstrate the relationship between function performance and resource allocation, and enable the scheduler to achieve the technical effect that the container placement is more resource-saving; by inferring the reasons of function performance problem, the following technical effects can be achieved, i.e. based on traditional performance monitoring, it is possible to effectively identify that performance reasons are originated from the inside of the system or the function itself, so that the service providers can handle effectively and differentially; by providing assurance for function performance and using performance monitoring and repair mechanisms to ensure that the function has uniform performance in different environments, the technical effect of improving service quality is achieved.

In the embodiments of the present disclosure, resource enhancement is mainly achieved by resource over-commitment; when placing containers, the memory allocated to each container is reduced, the effect is a corresponding increase in the number of containers allocated to each virtual machine, and a decrease in the number of virtual machines required to serve the same number of containers; at the same time, real-time monitoring on function performance is carried out, and alleviation or processing is performed promptly for a container that is problematic; therefore, the function performance will not be affected by resource over-commitment, the resource utilization of the cluster can be improved and the performance of containers is protected from being affected, the technical problem of low resource utilization is solved and the technical effect of improving resource utilization is achieved.

### Embodiment 2

According to the embodiments of the present disclosure, a resource processing apparatus used for implementing the resource processing method shown in FIG. 2 mentioned above is further provided.

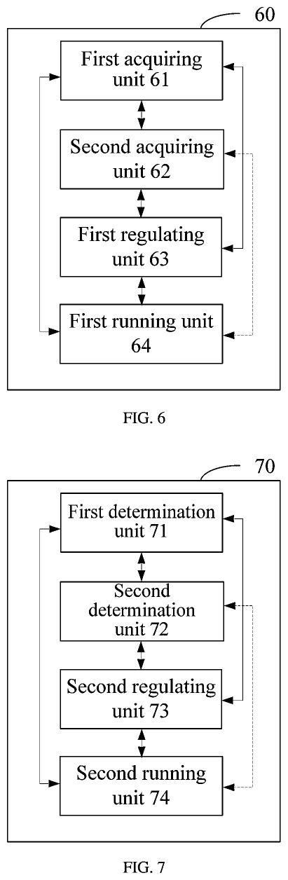

FIG. 6 is a schematic diagram of a resource processing apparatus according to an embodiment of the present disclosure. As shown in FIG. 6, the resource processing apparatus 60 may include: a first acquiring unit 61, a second acquiring unit 62, a first regulating unit 63, and a first running unit 64.

The first acquiring unit 61 is configured to acquire a target container of a target function, where the target container is configured to run the target function.

The second acquiring unit 62 is configured to acquire a current resource already allocated to the target container.

The first regulating unit 63 is configured to regulate the current resource to a target resource of the target container, where the target resource is determined based on the target function.

The first running unit 64 is configured to run, based on the target resource, the target function in the target container.

It should be noted here that, the first acquiring unit 61, the second acquiring unit 62, the first regulating unit 63, and the first running unit 64 mentioned above correspond to step S202 to step S208 in Embodiment 1, the instances and application scenarios implemented by the four units are the same as the instances and application scenarios implemented in the corresponding steps, but not limited to the content disclosed in Embodiment 1. It should be noted that the above units, as part of the apparatus, can run in the computer terminal 10 provided in Embodiment 1.

In an implementation, the first acquiring unit 61 includes: a first acquiring module and a first determination module, where the first acquiring module may include a first response module. Among them, the first acquiring module is configured to acquire profile data of the target function, where the profile data includes a maximum number of target containers allowed to be allocated to a virtual machine when the target container of the target function is co-located with a container of another function on the virtual machine; the first determination module is configured to determine, based on the profile data, a number of target containers allocated to the virtual machine; the first response module is configured to acquire the profile data of the target function, in response to the virtual machine being located in a first target area.

In an implementation, the first regulating unit 63 includes: a second response module, where the second response module may include: a second response subunit. Among them, the second response module is configured to reduce the current resource to the target resource, in response to the current resource not being fully utilized for the target container; the second response subunit is configured to: after reducing the current resource to the target resource, increase the target container allocated to a virtual machine from an original number to a target number based on the target resource.

In an implementation, the first regulating unit 63 further includes: a second acquiring module and a second determination module, where the second acquiring module may include a second acquiring subunit, the second determination module may include a second determination subunit. Among them, the second acquiring module is configured to acquire an average historical resource used by the target function during a historical period, where historical resources include the average historical resource; the second determination module is configured to determine the target resource based on the historical period and the average historical resource; the second acquiring subunit is configured to acquire a target parameter of the target function, where the target parameter is used to determine an over-commitment degree of the target resource; with respect to that the second determination module is configured to determine the target resource based on the historical period and the average historical resource, the second determination subunit is specifically configured to determining the target resource based on the historical period, the average historical resource, and the target parameter.

In an implementation, the first running unit 64 includes: a monitoring module and a migration module, where the monitoring module may include: a first monitoring subunit, a third acquiring subunit, and a third response subunit, the migration module may include: a migration subunit, a second monitoring subunit, and a fourth response subunit. Among them, the monitoring module is configured to monitor the target container to obtain a first monitoring result; the migration module is configured to perform migration processing or isolation processing on the target container, in response to the first monitoring result being used to indicate a performance degradation of the target function; the first monitoring subunit is configured to monitor the target container to obtain the first monitoring result, in response to a virtual machine to which the target container is allocated being located in a second target area; the third acquiring subunit is configured to acquire a delay duration for the target function in responding to a target request in the target container; the third response subunit is configured to determine that the first monitoring result is used to indicate the performance degradation of the target function, in response to the delay duration being greater than a target duration; the migration subunit is configured to migrate the target container from an original virtual machine to a target virtual machine, where the target virtual machine includes at least one of following: a virtual machine with a usage rate below a target threshold, a virtual machine already allocated with a same container as the target container, and a virtual machine located in a third target area without resource over-commitment; the second monitoring subunit is configured to monitor the target container subjected to the migration processing or the isolation processing, to obtain a second monitoring result; the fourth response subunit is configured to determine that the target function is in an abnormal state, in response to the second monitoring result being used to indicate the performance degradation of the target function. In the embodiments mentioned above of the present disclosure, the first acquiring unit 61 is configured to acquire a target container of a target function, where the target container is configured to run the target function; the second acquiring unit 62 is configured to acquire a current resource already allocated to the target container; the first regulating unit 63 is configured to regulate the current resource to a target resource of the target container, where the target resource is determined based on the target function; the first running unit 64 is configured to run, based on the target resource, the target function in the target container; that is to say, in the present disclosure, by reducing the allocated memory to an actual used part of each container of the function, the resource usage amount is reduced while ensuring that the function performance remains unchanged, the technical problem of low resource utilization is solved and the technical effect of improving resource utilization is achieved.

FIG. 7 is a schematic diagram of a resource processing apparatus according to an embodiment of the present disclosure. As shown in FIG. 7, the resource processing apparatus 70 may include: a first determination unit 71, a second determination unit 72, a second regulating unit 73, and a second running unit 74.

The first determination unit 71 is configured to determine a target area where a virtual machine is located in a virtual machine cluster.

The second determination unit 72 is configured to determine a target container of a target function based on the target area, where the target container of the target function is allowed to be allocated to the virtual machine, and the target container is configured to run the target function.

The second regulating unit 73 is configured to regulate a current resource already allocated to the target container to a target resource of the target container, where the target resource is determined based on the target function.

The second running unit 74 is configured to run, based on the target resource, the target function in the target container.

It should be noted here that, the first determination unit 71, the second determination unit 72, the second regulating unit 73, and the second running unit 74 mentioned above correspond to step S302 to step S308 in Embodiment 1, the instances and application scenarios implemented by the four units are the same as the instances and application scenarios implemented in the corresponding steps, but not limited to the content disclosed in Embodiment 1. It should be noted that the above units, as part of the apparatus, can run in the computer terminal 10 provided in Embodiment 1.

### Embodiment 3

An embodiment of the present disclosure further provides a computer readable storage medium. In an implementation of this embodiment, the storage medium mentioned above can be configured to store program codes for executing the resource processing method provided by Embodiment 1 mentioned above.

In an implementation of this embodiment, the storage medium can be located in any computer terminal in a computer terminal cluster in a computer network, or located in any mobile terminal in a mobile terminal cluster.

In an implementation of this embodiment, the storage medium mentioned above can be configured to store program codes for executing steps of: acquiring a target container of a target function, where the target container is configured to run the target function; acquiring a current resource already allocated to the target container; regulating the current resource to a target resource of the target container, where the target resource is determined based on the target function; and running, based on the target resource, the target function in the target container.

In an implementation, the computer-readable storage medium is further configured to store program codes for executing a step of: reducing the current resource to the target resource, in response to the current resource not being fully utilized for the target container.

In an implementation, the computer-readable storage medium is further configured to store program codes for executing a step of: after reducing the current resource to the target resource, increasing the target container allocated to a virtual machine from an original number to a target number based on the target resource.

In an implementation, the computer-readable storage medium is further configured to store program codes for executing a step of: acquiring an average historical resource used by the target function during a historical period, where historical resources include the average historical resource; and determining the target resource based on the historical period and the average historical resource.

In an implementation, the computer-readable storage medium is further configured to store program codes for executing steps of: acquiring a target parameter of the target function, where the target parameter is used to determine an over-commitment degree of the target resource; determining the target resource based on the historical period, the average historical resource, and the target parameter.

In an implementation, the computer-readable storage medium is further configured to store program codes for executing steps of: acquiring profile data of the target function, where the profile data includes a maximum number of target containers allowed to be allocated to a virtual machine when the target container of the target function is co-located with a container of another function on the virtual machine; and determining, based on the profile data, a number of target containers allocated to the virtual machine.

In an implementation, the computer-readable storage medium is further configured to store program codes for executing a step of: acquiring the profile data of the target function, in response to the virtual machine being located in a first target area.

In an implementation, the computer-readable storage medium is further configured to store program codes for executing steps of: monitoring the target container to obtain a first monitoring result; and performing migration processing or isolation processing on the target container, in response to the first monitoring result being used to indicate a performance degradation of the target function.

In an implementation, the computer-readable storage medium is further configured to store program codes for executing a step of: monitoring the target container to obtain the first monitoring result, in response to a virtual machine to which the target container is allocated being located in a second target area.

In an implementation, the computer-readable storage medium is further configured to store program codes for executing steps of: acquiring a delay duration for the target function in responding to a target request in the target container; and determining that the first monitoring result is used to indicate the performance degradation of the target function, in response to the delay duration being greater than a target duration.

In an implementation, the computer-readable storage medium is further configured to store program codes for executing a step of: migrating the target container from an original virtual machine to a target virtual machine, where the target virtual machine includes at least one of following: a virtual machine with a usage rate below a target threshold, a virtual machine already allocated with a same container as the target container, and a virtual machine located in a third target area without resource over-commitment.

In an implementation, the computer-readable storage medium is further configured to store program codes for executing steps of: after performing the migration processing or the isolation processing on the target container, monitoring the target container subjected to the migration processing or the isolation processing, to obtain a second monitoring result; and determining that the target function is in an abnormal state, in response to the second monitoring result being used to indicate the performance degradation of the target function.

As an implementation, the storage medium is further configured to store program codes for executing steps of: determining a target area where a virtual machine is located in a virtual machine cluster; determining a target container of a target function based on the target area, where the target container of the target function is allowed to be allocated to the virtual machine, and the target container is configured to run the target function; regulating a current resource already allocated to the target container to a target resource of the target container, where the target resource is determined based on the target function; and running, based on the target resource, the target function in the target container.

An embodiment of the present disclosure further provides a resource processing system, the resource processing system may include a computer terminal, where the computer terminal may be any computer terminal device in a computer terminal cluster. In an implementation of this embodiment, the computer terminal mentioned above can be replaced with a terminal device such as a mobile terminal.

In an implementation of this embodiment, the computer terminal mentioned above may be located in at least one of multiple network devices of a computer network.

In this embodiment, the computer terminal mentioned above can execute program codes of following steps in the resource processing method of the embodiments of the present disclosure: acquiring a target container of a target function, where the target container is configured to run the target function; acquiring a current resource already allocated to the target container; regulating the current resource to a target resource of the target container, where the target resource is determined based on the target function; and running, based on the target resource, the target function in the target container.

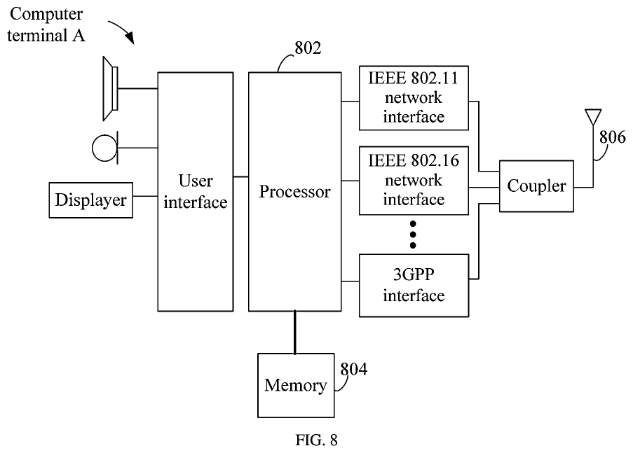

In an implementation, FIG. 8 is a block diagram of a structure of a computer terminal according to an embodiment of the present disclosure. As shown in FIG. 8, the computer terminal A may include: one or more (only one shown in the figure): processors 802, memories 804, and transmission apparatuses 806.

Among them, the memory can be configured to store software programs and modules, such as program instructions/modules corresponding to the resource processing method and apparatus in the embodiments of the present disclosure; the processor executes various functional applications and resource processing by running the software programs and modules stored in the memory, that is, implementing the resource processing method mentioned above. The memory may include a high-speed random access memory and may also include a non-volatile memory, such as one or more magnetic storage apparatuses, flash memories, or other non-volatile solid-state memories. In some instances, the memory may further include memories set remotely relative to the processor, these remote memories can be connected to the computer terminal A through a network. Instances of the network mentioned above include but are not limited to internet, intranet, local area network, mobile communication network, and their combinations.

The processor can call information and application programs stored in the memory through the transmission apparatus, to execute following steps: acquiring a target container of a target function, where the target container is configured to run the target function; acquiring a current resource already allocated to the target container; regulating the current resource to a target resource of the target container, where the target resource is determined based on the target function; and running, based on the target resource, the target function in the target container.

In an implementation, the processor mentioned above can further execute program codes of a following step: reducing the current resource to the target resource, in response to the current resource not being fully utilized for the target container.

In an implementation, the processor mentioned above can further execute program codes of a following step: after reducing the current resource to the target resource, increasing the target container allocated to a virtual machine from an original number to a target number based on the target resource.

In an implementation, the processor mentioned above can further execute program codes of following steps: acquiring an average historical resource used by the target function during a historical period, where historical resources include the average historical resource; and determining the target resource based on the historical period and the average historical resource.

In an implementation, the processor mentioned above can further execute program codes of following steps: acquiring a target parameter of the target function, where the target parameter is used to determine an over-commitment degree of the target resource; and, determining the target resource based on the historical period, the average historical resource, and the target parameter.

In an implementation, the processor mentioned above can further execute program codes of following steps: acquiring profile data of the target function, where the profile data includes a maximum number of target containers allowed to be allocated to a virtual machine when the target container of the target function is co-located with a container of another function on the virtual machine; and determining, based on the profile data, a number of target containers allocated to the virtual machine.

In an implementation, the processor mentioned above can further execute program codes of a following step: acquiring the profile data of the target function, in response to the virtual machine being located in a first target area.

In an implementation, the processor mentioned above can further execute program codes of following steps: monitoring the target container to obtain a first monitoring result; and performing migration processing or isolation processing on the target container, in response to the first monitoring result being used to indicate a performance degradation of the target function.

In an implementation, the processor mentioned above can further execute program codes of a following step: monitoring the target container to obtain the first monitoring result, in response to a virtual machine to which the target container is allocated being located in a second target area.

In an implementation, the processor mentioned above can further execute program codes of following steps: acquiring a delay duration for the target function in responding to a target request in the target container; and determining that the first monitoring result is used to indicate the performance degradation of the target function, in response to the delay duration being greater than a target duration.

In an implementation, the processor mentioned above can further execute program codes of a following step: migrating the target container from an original virtual machine to a target virtual machine, where the target virtual machine includes at least one of following: a virtual machine with a usage rate below a target threshold, a virtual machine already allocated with a same container as the target container, and a virtual machine located in a third target area without resource over-commitment.

In an implementation, the processor mentioned above can further execute program codes of following steps: after performing the migration processing or the isolation processing on the target container, monitoring the target container subjected to the migration processing or the isolation processing, to obtain a second monitoring result; and determining that the target function is in an abnormal state, in response to the second monitoring result being used to indicate the performance degradation of the target function.

As an implementation, the processor can further call information and application programs stored in the memory through the transmission apparatus, to execute following steps: determining a target area where a virtual machine is located in a virtual machine cluster; determining a target container of a target function based on the target area, where the target container of the target function is allowed to be allocated to the virtual machine, and the target container is configured to run the target function; regulating a current resource already allocated to the target container to a target resource of the target container, where the target resource is determined based on the target function; and running, based on the target resource, the target function in the target container.

The embodiments of the present disclosure are used to provide a resource processing solution. By means of: acquiring a target container of a target function, where the target container is configured to run the target function; acquiring a current resource already allocated to the target container; regulating the current resource to a target resource of the target container, where the target resource is determined based on the target function; and running, based on the target resource, the target function in the target container; that is to say, in the present disclosure, by reducing the allocated memory to an actual used part of each container of the function, the resource usage amount is reduced while ensuring that the function performance remains unchanged, the technical problem of low resource utilization is solved and the technical effect of improving resource utilization is achieved.

Those of ordinary skill in the art can understand that the structure shown in FIG. 8 is only for illustration, and the computer terminal A can also be a smartphone (such as an Android phone, iOS phone, etc.), a tablet, a handheld computer, a mobile internet device (MID), a PAD, and other terminal devices. FIG. 8 does not impose any limitations on the structure of the computer terminal A mentioned above. For example, the computer terminal A may also include more or fewer components (such as network interfaces, display devices, etc.) than shown in FIG. 8, or have a different configuration from that shown in FIG. 8.

Those of ordinary skill in the art can understand that all or part of the steps in the various methods of the embodiments mentioned above can be completed by instructing hardware related to the terminal device through a program, the program may be stored in a computer-readable storage medium, the storage medium may include: a flash drive, a read-only memory (ROM), a random access memory (RAM), a disk or an optical disc, etc.

Sequence numbers of the embodiments of the present disclosure mentioned above are only for description and do not represent the merits of the embodiments.

In the embodiments of the present disclosure mentioned above, the description of respective embodiment has its own emphasis. For parts without detailed description in one embodiment, please refer to the relevant descriptions of other embodiments.

In the several embodiments provided in the present disclosure, it should be understood that the disclosed technical content can be implemented through other means. The apparatus embodiments described above are only illustrative, such as the division of units is only a logical function division, there may be other division ways in actual implementation, for example, multiple units or components can be combined or integrated into another system, or some features can be ignored or not executed. Another point is that the coupling or direct coupling or communication connection displayed or discussed can be indirect coupling or communication connection through some interfaces, units or modules, or can be in the form of electrical or other forms.

Units described as separate components may be or may not be physically separated, and components displayed as units may be or may not be physical units, that is, they can be located in one place or distributed across multiple network units. Some or all units among them can be selected according to actual needs to achieve the objective of the solution of this embodiment.

In addition, in various embodiments of the present disclosure, respective functional units can be integrated into one processing unit, respective units can also physically exist separately, or two or more units can also be integrated into one unit. The integrated units mentioned above can be implemented in the form of hardware, and can also be implemented in the form of software functional units.

If the integrated unit is implemented in the form of a software functional unit and sold or used as an independent product, it can be stored in a computer-readable storage medium. Based on this understanding, the technical solution of the present disclosure can essentially, or in part contribute to the existing technology, or all or part of the technical solution can be reflected in the form of a software product, the computer software product is stored in a storage medium, including several instructions to enable a computer device (which can be a personal computer, a server, a network device, etc.) to perform all or part of the steps of the methods described in various embodiments of the present disclosure. The storage media mentioned above include: a USB disk, a read-only memory (ROM), a random access memory (RAM), a portable hard drive, a disk or CD, and other medium that can store program codes.

The above descriptions are only some embodiments of the present disclosure. It should be pointed out that, for those of ordinary skill in the art, several improvements and embellishments can be made without departing from the principles of the present disclosure, and these improvements and embellishments should also be considered as the scope of protection of the present disclosure.

1. A resource processing method, comprising:
acquiring a target container of a target function, wherein the target container is configured to run the target function;
acquiring a current resource already allocated to the target container;
regulating the current resource to a target resource of the target container, wherein the target resource is determined based on the target function; and
running, based on the target resource, the target function in the target container.

2. The method according to claim 1, wherein the regulating the current resource to the target resource of the target container comprises:
reducing the current resource to the target resource, in response to the current resource not being fully utilized for the target container.

3. The method according to claim 2, wherein after reducing the current resource to the target resource, the method further comprises:
increasing the target container allocated to a virtual machine from an original number to a target number based on the target resource.

4. The method according to claim 1, wherein the regulating the current resource to the target resource of the target container comprises:
acquiring an average historical resource used by the target function during a historical period, wherein historical resources comprise the average historical resource; and
determining the target resource based on the historical period and the average historical resource.

5. The method according to claim 4, further comprising:
acquiring a target parameter of the target function, wherein the target parameter is used to determine an over-commitment degree of the target resource;
the determining the target resource based on the historical period and the average historical resource comprises: determining the target resource based on the historical period, the average historical resource and the target parameter.

6. The method according to claim 1, further comprising:
acquiring profile data of the target function, wherein the profile data comprises a maximum number of target containers allowed to be allocated to a virtual machine when the target container of the target function is co-located with a container of another function on the virtual machine; and
determining, based on the profile data, a number of target containers allocated to the virtual machine.

7. The method according to claim 6, wherein the acquiring the profile data of the target function comprises:
acquiring the profile data of the target function, in response to the virtual machine being located in a first target area.

8. The method according to claim 1, further comprising:
monitoring the target container to obtain a first monitoring result; and
performing migration processing or isolation processing on the target container, in response to the first monitoring result being used to indicate a performance degradation of the target function.

9. The method according to claim 8, further comprising:
monitoring the target container to obtain the first monitoring result, in response to a virtual machine to which the target container is allocated being located in a second target area.

10. The method according to claim 8, wherein the monitoring the target container to obtain the first monitoring result comprises:
acquiring a delay duration for the target function in responding to a target request in the target container; and
determining that the first monitoring result is used to indicate the performance degradation of the target function, in response to the delay duration being greater than a target duration.

11. The method according to claim 8, wherein the performing the migration processing on the target container comprises:
migrating the target container from an original virtual machine to a target virtual machine, wherein the target virtual machine comprises at least one of following: a virtual machine with a usage rate below a target threshold, a virtual machine already allocated with a same container as the target container, and a virtual machine located in a third target area without resource over-commitment.

12. The method according to claim 8, wherein after performing the migration processing or the isolation processing on the target container, the method further comprises:
monitoring the target container subjected to the migration processing or the isolation processing, to obtain a second monitoring result; and
determining that the target function is in an abnormal state, in response to the second monitoring result being used to indicate the performance degradation of the target function.

13. A resource processing method, comprising:
determining a target area at which a virtual machine is located in a virtual machine cluster;
determining a target container of a target function based on the target area, wherein the target container of the target function is allowed to be allocated to the virtual machine, and the target container is configured to run the target function;
regulating a current resource already allocated to the target container to a target resource of the target container, wherein the target resource is determined based on the target function; and
running, based on the target resource, the target function in the target container.

14. A computer-readable storage medium comprising a program stored therein, wherein when the program is run by a processor, a device in which the computer-readable storage medium is located is controlled to execute the method according to claim 1.

15. The resource processing method according to claim 13, wherein the target area comprises a planed zone, a mixed zone, and a control zone;
the determining the target area at which the virtual machine is located in the virtual machine cluster comprises:
determining the target area is in one of the planned zone, the mixed zone, and the control zone.

16. The resource processing method according to claim 13, wherein the target container of the target function being allowed to be allocated to the virtual machine comprises:
acquiring profile data of the target function in response to a virtual machine being located in a first target area;
wherein the profile data comprises a maximum number of target containers allowed to be allocated to the virtual machine when the target container of the target function is co-located with a container of another function on the virtual machine.

17. The resource processing method according to claim 13, wherein the regulating the current resource already allocated to the target container to the target resource of the target container comprises:
monitoring the target container to obtain a first monitoring result, in response to a virtual machine to which the target container is allocated being located in a second target area; and
performing migration processing or isolation processing on the target container, in response to the first monitoring result being used to indicate a performance degradation of the target function.

18. The resource processing method according to claim 13, wherein the regulating the current resource already allocated to the target container to the target resource of the target container further comprises:
migrating the target container from an original virtual machine to a target virtual machine, wherein the target virtual machine comprises at least one of following: a virtual machine with a usage rate below a target threshold, a virtual machine already allocated with a same container as the target container, and a virtual machine located in a third target area without resource over-commitment.

19. A computer-readable storage medium comprising a program stored therein, wherein when the program is run by a processor, a device in which the computer-readable storage medium is located is controlled to execute the method according to claim 13.

20. A resource processing system, comprising: a processor; and a memory, connected with the processor and configured to provide, to the processor, instructions for processing the following processing steps:
acquiring a target container of a target function, wherein the target container is configured to run the target function;
acquiring a current resource already allocated to the target container;
regulating the current resource to a target resource of the target container, wherein the target resource is obtained based on a historical resource that is used by the target function during a historical period; and running, based on the target resource, the target function in the target container.
